(19) United States
(12) Patent Application Publication
(10) Pub. No.: US 2018/0034249 A1
(43) Pub. Date: Feb. 1, 2018

(54) Method And Device For Laying Gas-Insulated Tubular Conductors

(71) Applicant: SIEMENS AKTIENGESELLSCHAFT, MUENCHEN (DE)

(72) Inventors: ANDREAS DEHLER, MUENCHEN (DE); ANDREAS EBNER, NUERNBERG (DE); DENIS IMAMOVIC, NUERNBERG (DE); TOMASZ MAGIER, EGGOLSHEIM (DE); STEFAN SCHEDL, AMMERNDORF (DE)

(73) Assignee: Siemens Aktiengesellschaft, Munchen (DE)

(21) Appl. No.: 15/547,569

(22) PCT Filed: Jan. 7, 2016
(86) PCT No.: PCT/EP2016/050181

§ 371 Date: Jul. 31, 2017

(30) Foreign Application Priority Data
Jan. 30, 2015 (DE) 10 2015 201 659.5

(51) Int. Cl. H02G 1/06

(52) U.S. Cl. CPC H02G 1/06

(57) ABSTRACT

A device for laying gas-insulated tubular conductors includes a movable transport device for moving and advancing the device.

The invention relates to a device for laying gas-insulated tubular conductors.

Gas-insulated tubular conductors (GIL) comprise usually an electrical conductor that is electrically insulated from the environment by means of a suitable gas. The conductor is therefore usually arranged in a gas-tight tube. A tubular conductor of this type is known by way of example from DE 296 14 717 U1.

Since in order to lay gas-insulated tubular conductors it is necessary to ensure specific conditions such as by way of example clean conditions, a dust-free environment and good illumination, said conductors are laid by means of suitable devices that usually comprise assembly platforms that are newly constructed and assembled in each project dependent upon the prevailing spatial conditions. In the case of longer GIL lengths, the devices are dismantled after completion of one section of the tubular conductors and re-assembled at another site. Components of the devices that have already been used can only be re-used to a limited extent for the re-assembly procedure or also at the end of the construction site. The parts that are not used must be disposed of.

The object of the invention is to provide a device of the type mentioned in the introduction that renders it possible to lay gas-insulated tubular conductors in a cost-effective and reliable manner.

The object is achieved in the case of a generic device by virtue of the fact that drivable transport means are provided to move the device.

The drivable means for moving the device render it possible in an advantageous manner to omit having to dismantle and re-assemble the device. As a consequence, the gas-insulating conductors can be laid more quickly and thus in a more cost-effective manner. In addition, the device in accordance with the invention can be used to lay multiple section lengths of gas-insulated tubular conductors. It is likewise not necessary to organize possible assembly rooms for the device in dependence upon the project. This reduces the probability of errors occurring when assembling new GIL lengths. Further advantages of the device in accordance with the invention arise from the opportunity to optimize all the components used, the method and working steps when laying the GIL. All components of the device can be arranged in a similar manner in each project, as a result of which it is not necessary to relocate trained personnel to new workplaces. The device in accordance with the invention is advantageously ready for use immediately after being moved to the next deployment location. Further advantages are: it is not necessary to construct possible assembly halls or storage halls in dependence upon each project; set-up times for constructing possible temporary building structures including sub-constructions can be avoided; follow-up time for dismantling the temporary building structures and the sub-construction can likewise be avoided; it is not necessary to set up new workplaces and provide a power supply. It is possible to accelerate the procedures by virtue of partly mechanizing the working steps under always constant conditions. In addition, it is possible in this manner to advantageously increase the product quality and the reliability of the GIL.

The drivable transport means comprise in an expedient manner a running gear that is suitable for moving the device forward. By way of example, the transport means can comprise wheels or chains or rather caterpillar tracks.

In accordance with one embodiment of the invention, the transport means are provided for the passive movement of the device. This means that the device cannot be driven independently. In this case, the transport means can comprise suitable connection means for connecting to a separate vehicle. The device can then be moved to a different location by means of the vehicle. It is also feasible in this connection to move the device by means of a crane/truck or by means of pulling the assembly device across the pre-pared substrate (for example on rails or other elements). The device comprises in an expedient manner sub-constructions that can cooperate with the rails or other elements.

In accordance with an alternative embodiment of the invention, the transport means are provided so as to actively move the device. For this purpose, the transport means comprise by way of example a dedicated motor. In this case, the device can move independently. It is consequently possible to omit the separate vehicle.

The device preferably comprises an assembly platform having a unit for laying the tubular conductors. It is regarded as advantageous if the device comprises spaces that offer one or more of the following conditions for laying the gas-insulated tubular conductors: clean conditions, a dust-free environment, slight movements of air, temperature control and humidity control, good illumination, independence from weather conditions, adherence to regulations regarding safety at work, use of load-lifting means, easy-to-clean floors, facilities for the draught-free separation of work areas. Moreover, the assembly platform can comprise welding devices and/or other tools, in addition also at least one centering and/or orienting device. The device can furthermore comprise suitable pulling and lifting mechanisms. The pulling and lifting mechanisms can be used for the purpose of making individual tools and assembly devices, such as by way of example welding tools, available for multiple workplaces and/or to relocate the tubular conductors.

In accordance with a preferred embodiment, the assembly platform has a carrying force of at least 500 kg per square meter, preferably at least 700 kg per square meter. In this manner, a device is provided for laying gas-insulated tubular conductors and said device also renders it possible to lay multiple tubular conductor strands adjacent to one another.

In accordance with a further embodiment of the invention, the device comprises an intermediate storage unit for the intermediate storage of the tubular conductors. This intermediate storage of the tubular conductors renders it possible to accelerate the procedure of laying the gas-insulated tubular conductors.

Moreover, the invention relates to a method for laying gas-insulated tubular conductors.

The object of the invention is to propose a method of this type that renders it possible to lay the tubular conductors in a cost-effective and reliable manner.

The object is achieved in accordance with the invention by means of a method in which after the assembly of a section of the tubular conductors by means of an assembly device that is provided for this purpose, the assembly device is moved and subsequently a further section of the tubular conductors is assembled by means of the assembly device.

An individual section of the tubular conductors can comprise multiple tubular conductors that are arranged in sequence. In such a case, the section has a length of up to several hundred meters, by way of example up to 1000 m. An individual section of the tubular conductors can however comprise also by way of example a single tubular conductor. In this case, the section has a length between a few meters (by way of example 2 m) and 20 m.

In an advantageous manner, by virtue of the method in accordance with the invention it is achieved that it is not necessary to dismantle and re-assemble components of the device. This produces further advantages of the method in accordance with the invention that correspond to those advantages that have already been mentioned in connection with the device in accordance with the invention.

The device that is used in connection with the method in accordance with the invention for laying gas-insulated tubular conductors is preferably achieved by means of a device previously described in accordance with the invention.

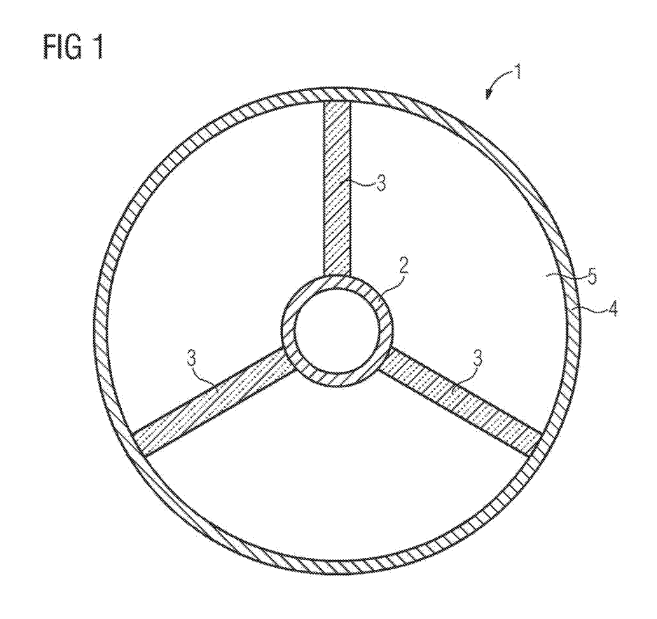

The invention is further explained herein under with reference to exemplary embodiments that are illustrated in the FIGS. 1-4.

FIG. 1 illustrates a schematic view of a cross-section through a gas-insulated tubular conductor;

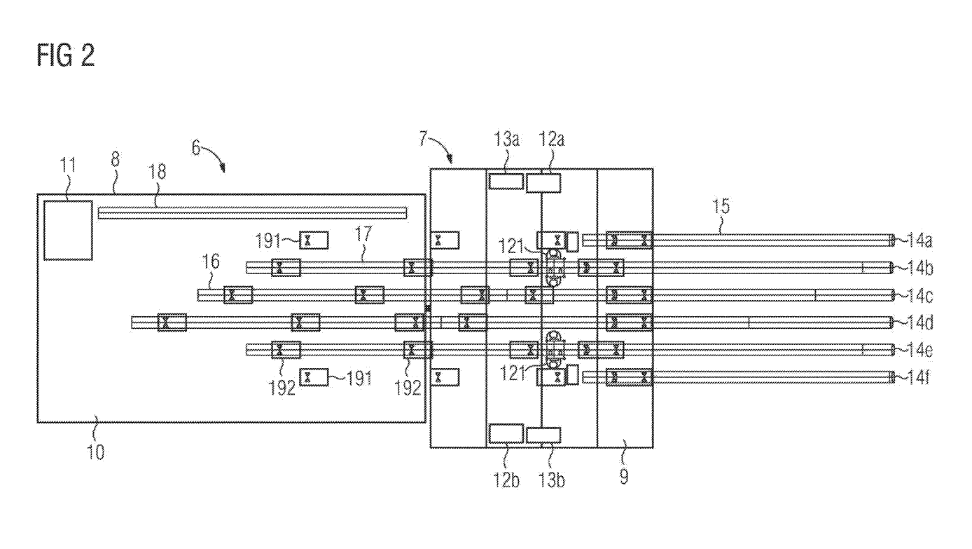

FIG. 2 illustrates a schematic view of an exemplary embodiment of a device in accordance with the invention;

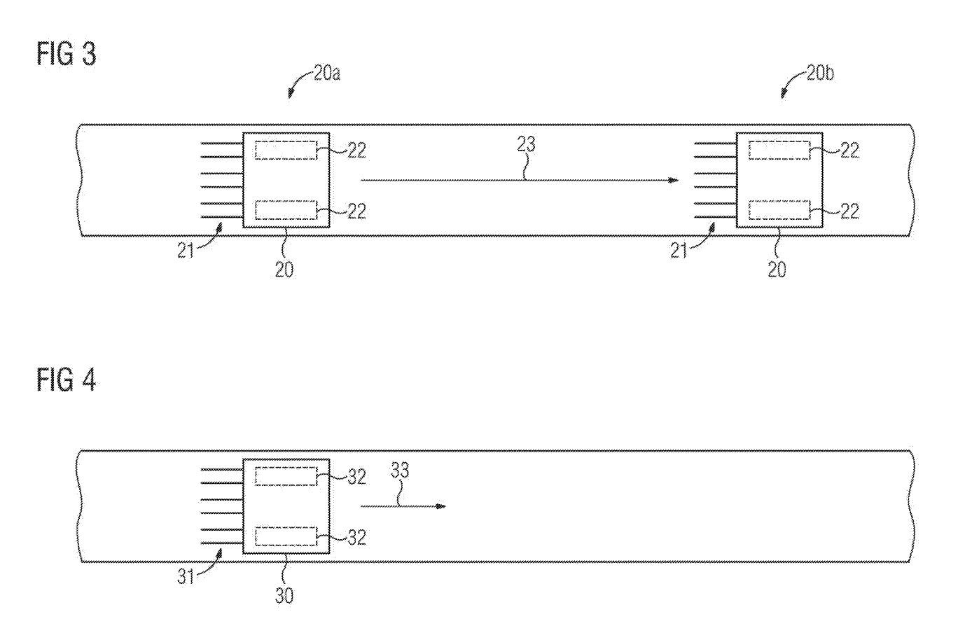

FIG. 3 illustrates a further exemplary embodiment of the device in accordance with the invention and also a procedure of relocating said device;

FIG. 4 illustrates an alternative further exemplary embodiment of the device in accordance with the invention and also a procedure of relocating said device.

In detail, FIG. 1 illustrates a cross-sectional view through a gas-insulated tubular conductor 1. The gas-insulated tubular conductor 1 comprises a current-carrying inner conductor 2 in the form of a tube that is produced by way of example from aluminum. The inner conductor 2 rests on supporting insulators 3 that are produced by way of example as cast-resin insulators. The insulators 3 center the inner conductor 2 within an outer sleeve 4. The outer sleeve 4 can by way of example likewise be manufactured from aluminum. In the case of laying said conductors directly on the earth, the outer sleeve 4 can be provided in addition with a suitable coating. An intermediate space 5 is provided between the inner conductor 2 and the outer sleeve 4. The intermediate space 5 is filled with an insulating gas. The insulating gas can comprise by way of example a gas mixture. The gas mixture can be formed by way of example from an 80 Vol-% N₂ and 20 Vol-% SF₆. However, other gases or gas mixtures are also feasible. The gas-insulated tubular conductor 1 that extends in a longitudinal direction forms one strand. A tubular conductor can comprise multiple such strands arranged adjacent to one another.

FIG. 2 illustrates a plan view of an exemplary embodiment of a device 6 in accordance with the invention. The device 6 comprises an assembly platform 7 and the intermediate storage unit 8. The assembly platform 7 and the intermediate storage unit 8 are connected to one another in a detachable manner. The assembly platform 7 comprises a drivable running gear (not visible in the illustration in FIG. 2) and a platform floor 9. Accordingly, the intermediate storage unit 8 likewise comprises a drivable running gear (not visible) and a storage unit floor 10.

The device comprises in addition welding devices 12a, 12b and also tool units 13a, 13b that are equipped with further tools that are necessary for assembling the tubular conductors. The welding devices 12a, 12b and the tool units 13a, 13b are arranged on the assembly platform.

The device 6 comprises moreover a diesel generator 11 that is arranged on the intermediate storage unit 8. The diesel generator is used to supply energy to the welding devices 12a, 12b and other tools of the device 6. In addition, the device 6 comprises orienting devices 191, 192, wherein the orienting devices 192 are already equipped with a tube. Furthermore, centering and welding tools 121 are provided. The centering and welding tools 121 can be fastened to a cover of the device 6 and can serve multiple workplaces by way of suitable pulling and lifting mechanisms (not illustrated in FIG. 2).

The device 6 is configured for laying six strands 14a-14f of tubular conductors simultaneously. Each strand 14a-14f comprises one or more tubular conductors. By way of example, the strand 14a comprises only a single tubular conductor 15 and the strand 14b comprises two tubular conductors 16 and 17. The tubular conductors in the embodiment of FIG. 2 are in each case from 11 m to 14 m in length. The tubular conductors are assembled for each strand by means of the device initially to form a tubular conductor section of approx. 500 m in length. Subsequently, the sections are finally connected to the tubular conductors that have already been laid.

The platform floor 9 has sufficient carrying force so that it does not collapse under the load of the tubular conductors that are to be assembled. In the illustrated exemplary embodiment, the carrying force of the assembly platform 7 and the intermediate storage platform is in each case approx. 700 kg/m².

The intermediate storage unit 8 is configured for the intermediate storage of tubular conductors in preparation for further processing. In the exemplary embodiment illustrated in FIG. 2, a tubular conductor 18 is arranged on the intermediate storage unit.

FIG. 3 illustrates a fundamental working procedure of an embodiment of a device 20 in accordance with the invention. In a first position 20a of the device 20, tubular conductors 21 are assembled in six strands. After the production of one section of the strands of approx. 500 m in length, the device 20 is moved by means of the drivable transport means 22 into a second position 20b that is approx. 500 m from the first position 20a, as indicated in FIG. 3 by means of an arrow 23. Subsequently, a further section of the strands of the tubular conductors 21 is assembled at the second position 20b.

FIG. 4 illustrates a possible alternative working procedure of an embodiment of a device 30 in accordance with the invention. In accordance with this variant, the tubular conductors 31 are assembled in six strands by means of the device 30. After the production of a section of the strands that in this case corresponds to a length of an individual tubular conductor, in other words in the illustrated exemplary embodiment a length of approx. 11 m to 14 m, by way of example 11.5 m, the device 30 is moved by approximately one tubular conductor length by means of the drivable transport means 32, as indicated in FIG. 4 by an arrow 33. Subsequently, a further tubular conductor is assembled for each of the strands.

### LIST OF REFERENCE NUMERALS

1 Gas-insulated tubular conductor
2 Inner conductor
3 Supporting insulator
4 Outer sleeve
5 Intermediate space
6, 20, 30 Device for laying gas-insulated tubular conductors
7 Assembly platform
8 Intermediate storage unit
9 Platform floor
10 Storage unit floor
11 Diesel generator
12a, 12b Welding device
13a, 13b Tool units
121 Centering and welding tools
191, 192 Orienting device
14a-f Strand of tubular conductors
16, 17, 18 Tubular conductors
20a, 20b Position of the device
21, 31 Tubular conductors
22, 32 Transport means
23, 33 Arrow

1-8 (canceled)

9. An assembly for laying gas-insulated tubular conductors, the assembly comprising:
a device for laying the gas-insulated tubular conductors; and
a driven transport apparatus for moving said device.

10. The assembly according to claim 9, wherein said transport apparatus is configured for a passive movement of said device.

11. The assembly according to claim 9, wherein said transport apparatus is configured for an active movement of said device.

12. The assembly according to claim 9, wherein said device comprises an assembly platform having a unit for assembling the tubular conductors.

13. The assembly according to claim 12, wherein said assembly platform has a carrying capacity of at least 500 kg/m².

14. The assembly according to claim 9, wherein said device comprises an intermediate storage unit for an intermediate storage of the tubular conductors.

15. A method for laying gas-insulating tubular conductors, the method comprising:
providing an assembly device configured to assemble tubular conductors; and
following an assembly of a section of a tubular conductor by the assembly device,
moving the assembly device for laying the section of the tubular conductor; and
subsequently assembling a further section of the tubular conductors by the assembly device.

16. The method according to claim 15, wherein the providing step comprises providing an assembly according to claim 9 and assembling and laying the sections of tubular conductors with the assembly.
